(19) United States
(12) Patent Application Publication
(10) Pub. No.: US 2013/0164110 A1
(43) Pub. Date: Jun. 27, 2013

(54) PICK-AND-PLACE DEVICE

(71) Applicant: KUO-FONG TSENG, Tu-Cheng (TW)

(72) Inventor: KUO-FONG TSENG, Tu-Cheng (TW)

(21) Appl. No.: 13/662,627

(22) Filed: Oct. 29, 2012

(30) Foreign Application Priority Data
Dec. 27, 2011 (TW) 100148901

(51) Int. Cl. B65G 49/00

(52) U.S. Cl. 414/749.1

(57) ABSTRACT

A pick-and-place device for transferring and positioning a plurality of workpieces includes a transferring mechanism and a handling assembly. The handling assembly includes at least two handling heads. Each of the at least two handling heads includes a handling portion for handling the plurality of workpieces. The handling portions of the at least two handling heads have different sizes. The transferring mechanism is capable of picking one of the handling head of the at least two handling heads according to sizes of the plurality of workpieces.

### BACKGROUND

1. Technical Field

The present disclosure relates to a handling device, and particularly to a pick-and-place device used during a semiconductor production process.

2. Description of the Related Art

During a semiconductor production process, after wafers are cut into a plurality of dies, the dies and integrated circuits are required to be moved to and adhered to substrates by a pick-and-place device. The pick-and-place device includes a transferring mechanism. The transferring mechanism includes a handling member. The dies and the integrated circuits are handled and adhered to the substrate by the handling member. A size of the handling member is fixed, so the handling member can only match with the dies and the integrated circuits having corresponding sizes. However, some semiconductors are needed to adhere to dies and integrated circuits of different sizes which require different handling members of different sizes. Requiring handling members capable of handling dies and integrated circuits of different sizes may reduce production efficiency and increase production cost.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a layout for one embodiment of a pick-and-place device used for handling a plurality of dies and integrated circuits to a substrate placed on a support platform, wherein the pick-and-place device includes a transferring mechanism, a first handling head, a second handling head, and a bracket.

FIG. 2 illustrates that the integrated circuit is handled by the first handling head picked by the transferring mechanism.

FIG. 3 illustrates that the first handling head is placed in the bracket.

FIG. 4 illustrates that the second handling head is picked by the transferring mechanism.

FIG. 5 illustrates that the die is handled by the second handling head.

FIG. 6 illustrates that the die and the integrated circuit are adhered to the substrate, and the first and second handling heads are placed in the bracket.

### DETAILED DESCRIPTION

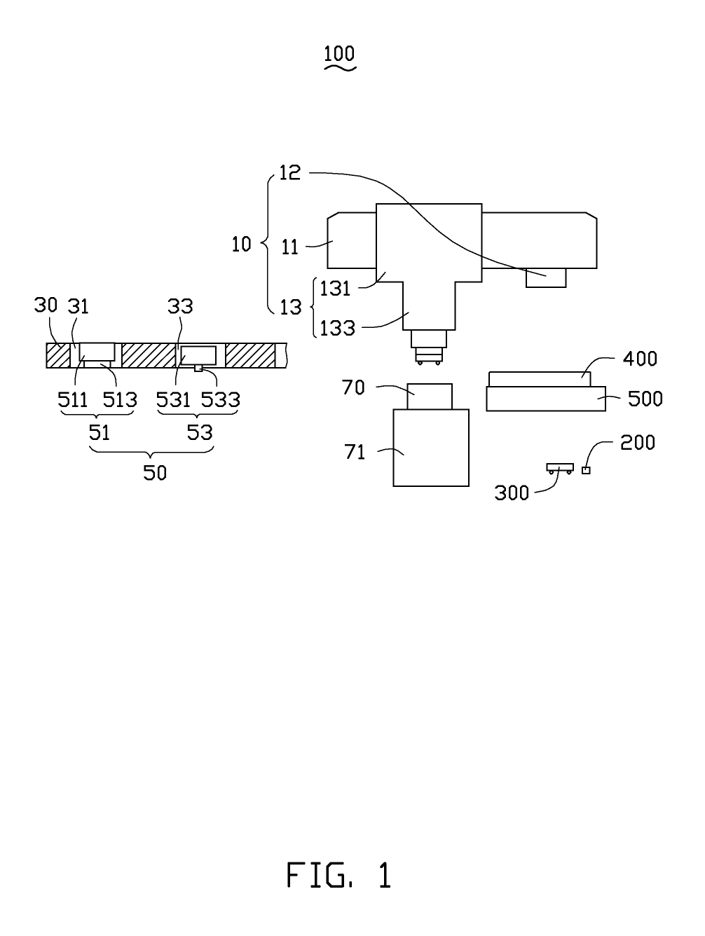

FIG. 1 shows one embodiment of a pick-and-place device 100. The pick-and-place device 100 is used for handling workpieces (not labeled) to a substrate 400. In the illustrated embodiment, the workpieces includes a plurality of dies 200 and a plurality of integrated circuits 300. The substrate 400 is placed on a support platform 500. An adhesive layer (not shown) is coated on the substrate 400 for adhering to the dies 200 and the integrated circuits 300. The pick-and-place device 100 includes a transferring mechanism 10, a bracket 30, a handling assembly 50 placed on the bracket 30, and a detection platform 70 adjacent to the bracket 30. The transferring mechanism 10 is movably disposed above the bracket 30, the handling assembly 50, and the detection platform 70.

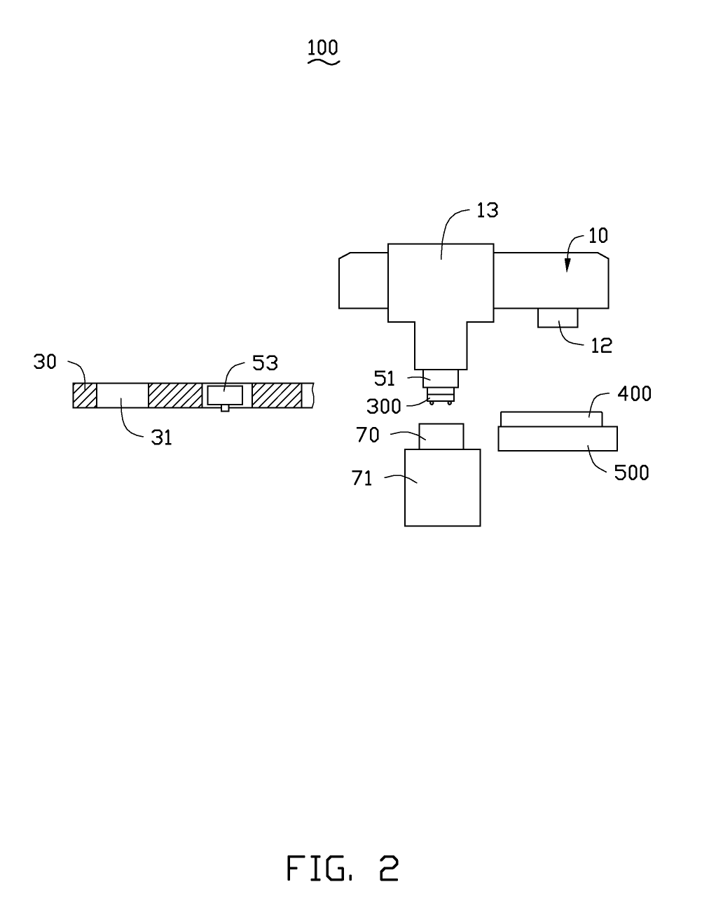

Referring also to FIG. 2, the transferring mechanism 10 includes a transferring shaft 11, a position detector 12 mounted on the transferring shaft 11, and a picking member 13 mounted on the transferring shaft 11. The transferring shaft 11 is movably controlled by a control mechanism (not shown). The picking member 13 is movable with the transferring shaft 11. The position detector 12 is placed on the transferring shaft 11, for detecting a predetermined position of the dies 200 or the integrated circuits 300 on the substrate 400 and transmitting the detection data to the control mechanism. Thus, the transferring mechanism 10 can be controlled to move to a predetermined position. The picking member 13 includes a body portion 131 and a picking portion 133 connected with the body portion 131. The body portion 131 is mounted on the transferring shaft 11, and is movable with the transferring shaft 11. The picking portion 133 is controlled by the control mechanism to pick or place the handling assembly 50.

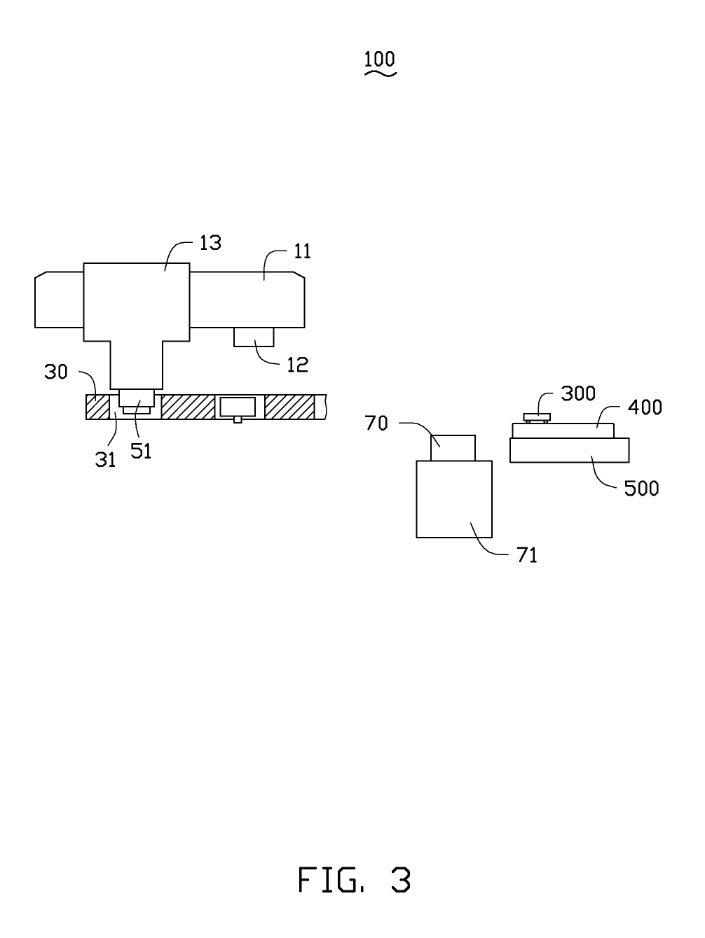

Referring also to FIG. 3, the bracket 30 is configured for receiving and bearing the handling assembly 50. A first receiving portion 31 and a second receiving portion 33 are defined in the bracket 30 spaced from each other, for receiving and bearing the handling assembly 50.

The handling assembly 50 includes a first handling head 51 and a second handling head 53. The first handling head 51 is placed in the first receiving portion 31. The second handling head 53 is placed in the second receiving portion 33. The first handling head 51 includes a body 511 and a handling portion 513 perpendicularly connected with the body 511. The body 511 is received in the first receiving portion 31. In the illustrated embodiment, a size of the handling portion 513 is matched with that of each of the integrated circuits 300, to handle each of the integrated circuits 300 placed on the detection platform 70.

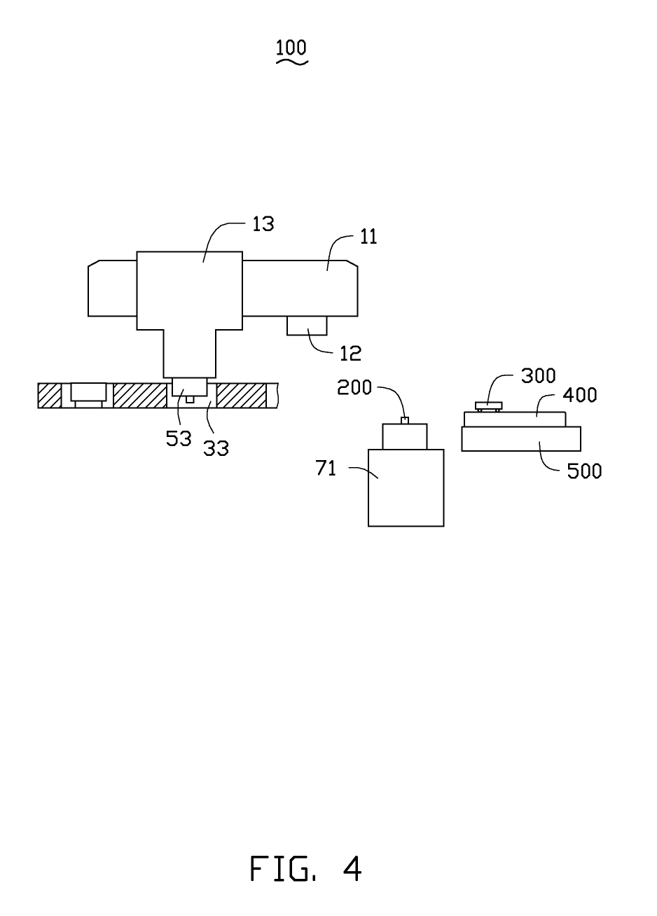

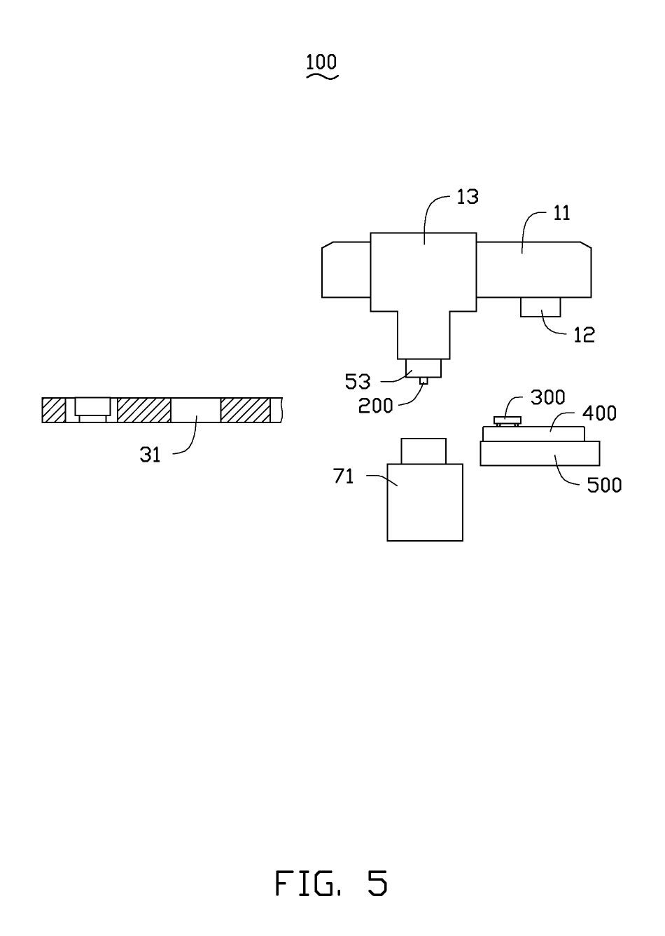

Referring to FIGS. 4 and 5, the second handling head 53 has a similar structure to the first handling head 51. The second handling head 53 includes a body 531 and a handling portion 533 perpendicularly connected with the body 531. The body 531 is received in the second receiving portion 33. A size of the handling portion 533 is matched with each of the plurality of dies 200, to handle the dies 200 placed on the detection platform 70. In the illustrated embodiment, the first handling head 51 and the second handling head 53 are bonding heads.

In other embodiments, the handling assembly 50 can further include other handling heads, and accordingly, the bracket 30 can further define other receiving portions.

The detection platform 70 is placed between the bracket 30 and the support platform 500. The detection platform 70 includes an image sensor 71, for detecting sizes of the dies 200 and the integrated circuits 300 placed on the detection platform 70, and transmitting the detecting data to the control mechanism. Then, the transferring mechanism 10 is moved above the first handling head 51 or the second handling head 53, accordingly.

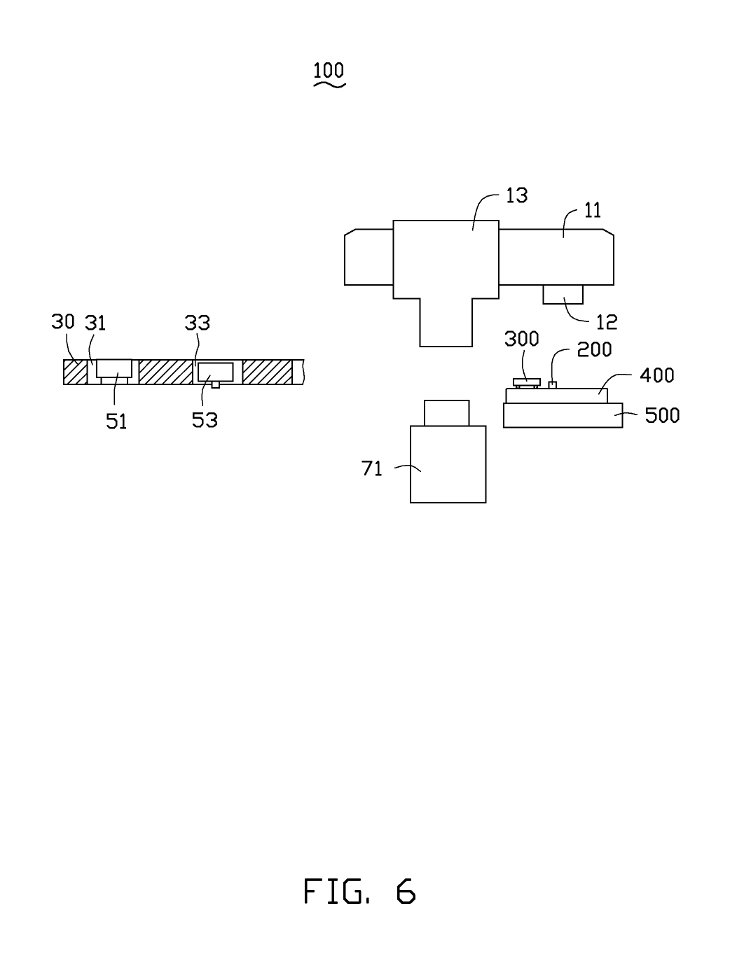

Referring to FIGS. 1 through 6, in use, each of the integrated circuits 300 is placed on the detection platform 70, and the substrate 400 coated with the adhesive layer is placed on the support platform 500; the size of each of the integrated circuits 300 is detected by the image sensor 71, and the detecting data is transmitted to the control mechanism; the transferring shaft 11 is moved above the bracket 30 controlled by the control mechanism, and the first handling head 51 is picked by the picking member 13; the transferring shaft 11 is then moved above the detection platform 70 , and each of the integrated circuits 300 is handled by the handling portion 513 (referring to FIG. 2); a predetermined position of each of the integrated circuits 300 in the substrate 400 is detected by the position detector 12, and the detecting data are transmitted to the control mechanism; the transferring shaft 11 is moved above the substrate 400, and each of the integrated circuits 300 is adhered to the substrate 400 at the predetermined position; each of the plurality of dies 200 is placed the detection platform 70, a size of each of the plurality of dies 200 is detected by the image sensor 71, and the detecting data are transmitted to the control mechanism; the transferring shaft 11 is moved above the first receiving portion 31, and then the first handling head 51 is placed in the first receiving portion 31 (referring to FIG. 3); the transferring shaft 11 is moved above the second receiving portion 33, and then the second handling head 53 is picked by the picking member 13 (referring FIG. 4); the transferring shaft 11 is moved above the detection platform 70, and then each of the plurality of dies 200 is handled by the second handling head 53; a predetermined position of each of the plurality of dies 200 in the substrate 400 is detected by the position detector 12, and the detecting data is transmitted to the control mechanism; the transferring shaft 11 is moved above the substrate 400, and each of the dies 200 is adhered to the substrate 400 at the predetermined position; finally, the transferring shaft 11 is moved above the bracket 30, and the second handling head 53 is placed in the second receiving portion 33 (referring to FIGS. 5 and 6).

Because the handling portion 513 of the first handling head 51 is matched with each of the integrated circuits 300, and the handling portion 533 of the second handling head 53 is matched with each of the dies 200, the pick-and-place device 100 can handle the integrated circuits 300 and the dies 200 which are of different sizes. Thus, different pick-and-place devices matched with different sizes are not needed, and an efficiency of handling is improved with a lower cost.

In other embodiments, the bracket 30 can be omitted, and the handing assembly 50 is placed on the support platform 500. The detection platform 70 can be omitted, and the dies 200 and the integrated circuits 300 are placed on the support platform 500. the workpieces can further include other components as the pick-and-place device 100 applied, for example, a plurality of wafers.

It is to be understood, however, that even through numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A pick-and-place device for transferring and positioning a plurality of workpieces, the pick-and-place device comprising:
a transferring mechanism; and
a handling assembly comprising at least two handling heads, wherein each of the at least two handling heads comprises a handling portion configured to handle the plurality of workpieces, each of the handling portions of the at least two handling heads has a different size, and the transferring mechanism is capable of picking one of the handling head of the at least two handling heads according to sizes of the plurality of workpieces.

2. The pick-and-place device of claim 1, wherein the at least two handling heads comprise a first handling head and a second handling head, the first handling head comprises a handling portion, the second handling head comprises a handling portion, a size of the handling portion of the first handling head is different from a size of the handling portion of the second handling head.

3. The pick-and-place device of claim 1, wherein the transferring mechanism comprises a picking member, the picking member comprises a picking portion, and the picking portion is capable of picking each of the at least two handling heads.

4. The pick-and-place device of claim 3, wherein the transferring mechanism further comprises a transferring shaft, the transferring shaft is movable, the picking member is mounted on and movable with the transferring shaft.

5. The pick-and-place device of claim 4, wherein the transferring mechanism further comprises a position detector mounted on the transferring shaft, the position detector is capable of detecting predetermined positions of the plurality of workpieces to be placed.

6. The pick-and-place device of claim 1, wherein the pick-and-place device further comprises a bracket configured to receive and bear the handling assembly.

7. The pick-and-place device of claim 6, wherein the bracket defines at least two receiving portions, and the at least two receiving portions are correspondingly positioned relative to the at least two handling heads and are spaced from each other.

8. The pick-and-place device of claim 1, wherein the at least two handling heads are bonding heads.

9. The pick-and-place device of claim 1, wherein the pick-and-place device further comprises a detection platform, the detection platform is capable of detecting sizes of the plurality of workpieces.

10. The pick-and-place device of claim 9, wherein the detection platform comprises an image sensor, the image sensor is capable of detecting sizes of the plurality of workpieces.

11. A pick-and-place device for transferring and positioning a plurality of workpieces, the pick-and-place device comprising:
a transferring mechanism comprising a picking member;
a handling assembly comprising at least two handling heads; and
a bracket configured to receive and bear the handling assembly;
wherein each of the at least two handling heads comprises a handling portion configured to handle the plurality of workpieces, each of the handling portions of the at least two handling heads has a different size, and the picking member is capable of picking one of the handling head of the at least two handling heads according to sizes of the plurality of workpieces.

12. The pick-and-place device of claim 11, wherein the at least two handling heads comprise a first handling head and a second handling head, the first handling head comprises a handling portion, the second handling head comprises a handling portion, a size of the handling portion of the first handling head is different from a size of the handling portion of the second handling head.

13. The pick-and-place device of claim 11, wherein the transferring mechanism further comprises a transferring shaft, the transferring shaft is movable, the picking member is mounted on and movable with the transferring shaft.

14. The pick-and-place device of claim 13, wherein the transferring mechanism further comprises a position detector mounted on the transferring shaft, the position detector is capable of detecting predetermined positions of the plurality of workpieces to be placed.

15. The pick-and-place device of claim 11, wherein the bracket defines at least two receiving portions, the at least two receiving portions are correspondingly positioned relative to the at least two handling heads and are spaced from each other.

16. The pick-and-place device of claim 11, wherein the at least two handling heads are bonding heads.

17. The pick-and-place device of claim 11, wherein the pick-and-place device further comprises a detection platform, the detection platform is capable of detecting sizes of the plurality of workpieces.

18. The pick-and-place device of claim 17, wherein the detection platform comprises an image sensor, the image sensor is capable of detecting sizes of the plurality of workpieces.
